(19) United States
(12) Patent Application Publication
(10) Pub. No.: US 2017/0067670 A1
(43) Pub. Date: Mar. 9, 2017

(54) COOLING OF AN ELECTRIC MACHINE

(71) Applicant: SIEMENS AKTIENGESELLSCHAFT, 80333 München (DE)

(72) Inventors: HORST KÜMMLEE, Berlin (DE); FRANK SEIBICKE, Borkheide (DE)

(73) Assignee: SIEMENS AKTIENGESELLSCHAFT, 80333 München (DE)

(21) Appl. No.: 15/119,974

(22) PCT Filed: Jan. 21, 2015
(86) PCT No.: PCT/EP2015/051110

§ 371 Date: Aug. 18, 2016

(30) Foreign Application Priority Data
Feb. 19, 2014 (EP) 14155749.6

(51) Int. Cl. F25B 21/00; H02K 9/22

(52) U.S. Cl. CPC F25B 21/00; H02K 9/22; F25B 2321/0022

(57) ABSTRACT

The invention relates to an electric machine, comprising a first cooling section (1), in which a first cooling medium for cooling the electric machine is provided, and a second cooling section (2), in which a second cooling medium is provided. In order to provide an alternative to known cooling systems for electric machines, the electric machine according to the invention has at least one active part (3) and at least one heat transport element (4) comprising a magnetocaloric material, wherein a magnetic field (5) can be applied to the at least one heat transport element (4) at least partially and/or at least temporarily by means of the at feast one active part (3), wherein the at least one active part (3) and the at least one heat transport element (4); are designed in such a way that waste heat can be transferred from the first cooling medium to the second cooling medium by using the magnetocaloric effect.

The invention relates to an electric machine comprising a first cooling section in which a first cooling medium for cooling the electric machine is provided and a second cooling section in which a second cooling medium is provided.

During the operation of electric machines a great number of losses occur, said losses being converted into heat and leading to the heating of the electric machine.

In order to prevent inadmissible heating of the materials in the electric machine, sufficient cooling has to be ensured. This may be carried out in the simplest case via natural convection on the surface. From specific power classes and size classes of machine, the cooling should be carried out via cooling circuits and heat exchangers.

The temperature difference between the cooling medium in the primary circuit inside the machine and the cooling medium in the secondary circuit outside the machine is a characteristic feature for the cooling of the machine. In this case the initial temperature in the primary circuit is generally above the cold temperature of the secondary medium. The admissible heating of the electric machine up to the maximum admissible winding temperature is determined according to the initial temperature of the secondary medium and this temperature difference.

The object of the invention is to provide an alternative to known cooling systems for electric machines.

This object is achieved by an electric machine of the type mentioned in the introduction, in that the electric machine has at least one active part and at least one heat transport element comprising a magnetocaloric material, wherein a magnetic field can be applied to the at least one heat transport element at least partially and/or at least temporarily by means of the at least one active part, wherein the at least one active part and the at least one heat transport element are designed in such a way that waste heat can be transferred from the first cooling medium to the second cooling medium by using the magnetocaloric effect.

Possible magnetocaloric materials are, for example, paramagnetic salts, such as cerium magnesium nitrate or gadolinium (Gd) and gadolinium alloys, such as for example GdDy, GdTb. Moreover, materials which are known as GMCE (Giant Magnetocaloric Effect) materials may be used, such as for example the alloys Gd₅(SiₓGe₁₋ₓ)₄, La(FeₓSi₁₋ₓ)₁₃Hₓ and MnFeP₁₋ₓAsₓ.

In particular, the first cooling section may be designed as a closed cooling circuit and/or primary circuit, so that an exchange or mixing of the first cooling medium with the second cooling medium is at least substantially prevented. In principle, the second cooling section may also be designed independently of the first cooling section as a closed cooling circuit and/or secondary circuit. Alternatively, it is conceivable that the first cooling section and/or the second cooling section are designed to be open, in the sense that the first cooling medium and/or the second cooling medium are able to mix with other cooling media and a closed circuit does not necessarily have to be present in each case. Preferably, a gaseous or liquid fluid is used as the respective cooling medium, for example air, water or oil, wherein the same or different fluids may be used as the first cooling medium and as the second cooling medium.

One feature of the present invention is to lower the initial temperature and/or cold temperature of the first cooling medium in the first cooling section of the electric machine by using the magnetocaloric effect. At the same time, the temperature of the second cooling medium in the second cooling section is increased so that a greater temperature difference is able to be achieved between the first cooling medium and the second cooling medium.

With the magnetocaloric effect, a suitable material is heated and/or cooled by increasing the application of a magnetic field and/or by reducing the application of a magnetic field. This is due to the fact that without the effect of a magnetic field the material has magnetic moments which have no preferred direction. In an adiabatic process, a magnetic field is applied to the material, whereby the magnetic moments are aligned and the entropy associated with the alignment of the magnetic moments is reduced. Since the process is adiabatic, the overall entropy is maintained so that the entropy associated with the temperature of the material is increased, which results in a rise in temperature of the material. Conversely, the preferred direction of the magnetic moments is lost during an adiabatic process when the application of a magnetic field is terminated, so that the entropy associated with the alignment of the magnetic moments is increased. Once again, the overall entropy is maintained so that the entropy associated with the temperature of the material is reduced, which is why a drop in temperature of the material may be observed.

The at least one active part is able to apply a magnetic field at least partially and/or at least temporarily to the at least one heat transport element. For example, the respective active part is able to be operated electrically and designed as an electric winding, coil or coil pair. The respective active part may, however, also be implemented by means of permanent magnets or the like. In particular, an arrangement may be provided in which at least one magnet pair, for example a coil pair or permanent magnet pair, has an intermediate space between the magnet pair, wherein the heat transport element is located at least partially and/or at least temporarily in the intermediate space.

For example, the magnetic field which is able to be generated by at least one active part may be varied over time and/or switched on and switched off so that the magnetic field may be at least partially and/or at least temporarily applied to the respective heat transport element. Additionally or alternatively, a relative movement of the respective active part may be used with regard to the respective heat transport element in order to achieve the aforementioned application of the magnetic field. For example, to this end the respective active part may carry out a translatory or rotary movement with one respective stationary heat transport element and/or vice versa. For example, a translatory and/or rotary movement produced by the electric machine may also be used for the aforementioned heating and/or cooling of the respective heat transport element when the magnetic field is applied and/or when the application of the magnetic field is terminated. Thus the translation and/or the rotation of the electric machine may be used together, by one respective heat transport element being operated for cooling electric machines on the basis of the magnetocaloric effect, wherein the respective heat transport element is connected, for example, fixedly to a movable part of the electric machine and/or fixedly to the structure of a movable part of the electric machine via a mechanical transmission. Moreover, a combination of the variation of the magnetic field over time with the relative movement may be used in order to ensure the at least partial and/or at least temporary application of the magnetic field on the respective heat transport element.

Finally, the at least partial and/or at least temporary application of the magnetic field on the respective heat transport element enables waste heat to be able to be transferred from the first cooling medium to the second cooling medium by using the magnetocaloric effect. In particular, the first cooling section and the second cooling section may be appropriately designed therefor. Preferably, it is provided that the waste heat of the first cooling medium is able to be transferred to the respective heat transport element if the respective heat transport element has been cooled at least partially and/or at least temporarily by means of the magnetocaloric effect. Advantageously, the waste heat of the respective heat transport element is able to be transferred to the second cooling medium if the respective heat transport element has been heated at least partially and/or at least temporarily by means of the magnetocaloric effect.

As a whole, therefore, an alternative to the known cooling systems for electric machines is proposed, wherein an improved removal of waste heat of the first cooling medium is enabled, in particular, and thus an improved cooling of the electric machine. By reducing the cold temperature of the primary medium, for example, the admissible heating and/or the output of the electric machine is increased.

In one advantageous embodiment of the invention, the respective heat transport element is arranged in the electric machine so as to be able to be rotated about an axis of rotation and/or so as to be able to be moved in a translatory manner, wherein a first element region of the respective heat transport element is arranged in a first machine region of the electric machine, the at least one active part being able to apply the magnetic field thereto, wherein a second element region of the respective heat transport element is arranged in a second machine region outside the first machine region.

In particular, if the electric machine is designed as an electric motor or generator, the axis of rotation may be the axis of rotation of a shaft or a rotor of the electric machine. In this case, it may be provided that the respective heat transport element, for example, is fixed in terms of rotation or connected to the shaft or the rotor via a gear mechanism.

The respective heat transport element has a first element region and a second element region which may be formed, for example, by the two halves of the respective heat transport element. The first element region in this case is arranged in the first machine region, the at least one active part being able to apply the magnetic field thereto, so that the magnetic field is also able to be applied to the first element region. The second element region is located in the second machine region which is arranged outside the first machine region. In particular, the first machine region may be a region of the electric machine where a particularly powerful magnetic field is able to be applied thereto, whereas the second machine region may be a region of the electric machine where only a relatively weak or no magnetic field at all is able to be applied or is applied thereto.

If the respective heat transport element performs a rotation, the first element region and/or the second element region is that region which is currently arranged in the first machine region and/or in the second machine region. If a specific point of the respective transport element rotating around the axis of rotation is considered, therefore, during the rotation this point is sometimes located in the first element region and sometimes in the second element region, depending on whether the point is currently located in the first machine region or in the second machine region.

In this manner, an effective cycle may be obtained in which individual points of the respective heat transport element pass through the above-described processes of the adiabatic heating and the adiabatic cooling and thus are able to absorb waste heat of the first cooling medium particularly efficiently and are able to discharge waste heat to the second cooling medium particularly efficiently. In this case, adiabatic processes are generally already present at relatively low rotational speeds.

Instead of the described rotational movement, it may also be provided that the respective heat transport element is able to be moved in a translatory manner in the electric machine, which is the case, in particular, in a linear motor. Moreover, for a translatory movement of the respective heat transport element, the electric machine may be designed such that the above-described first and second machine regions are present and that the respective heat transport element has the above-described first and second element regions. In this case, mixed forms of a rotary and translatory movement of the respective heat transport element may also be implemented.

As a whole, therefore, the translatory and/or rotary movement produced by the electric machine may be used for the aforementioned heating and/or cooling of the respective heat transport element, in particular when the respective heat transport element is driven via a rotor assembly of the electric machine.

In a further advantageous embodiment of the invention, in this case the respective active part is designed such that the magnetic field is aligned substantially along the axis of rotation.

The first element region and the second element region, viewed in this case in cross section perpendicular to the axis of rotation, may be two opposing halves of the respective heat transport element, for example. The respective active part may be designed such that a particularly powerful magnetic field may be applied to the first element region, in particular one of the two halves, in the direction of the axis of rotation, whereas a relatively weak or no magnetic field at all is able to be applied or is applied to the second element region, in particular the other half.

In an alternative further advantageous embodiment of the invention, the respective active part in this case is designed such that the magnetic field is aligned substantially perpendicular to the axis of rotation.

The first element region and the second element region, also viewed in cross section perpendicular to the axis of rotation, may be two opposing halves of the respective heat transport element, for example. The respective active part may be designed such that a particularly powerful magnetic field may be applied the first element region, in particular to one of the two halves perpendicular to the axis of rotation, whereas a relatively weak or no magnetic field at all is able to be applied or is applied to the second element region, in particular the other half.

In the example where the axis of rotation faces in the direction of the z-axis of a cartesian coordinate system, the direction of the magnetic field may face, for example, consistently in the x-direction. It is also conceivable that the magnetic field is not uniform spatially and the magnetic field lines, for example, describe an arc with components in the x-direction and in the y-direction.

In a further advantageous embodiment of the invention, in this case the first cooling section is designed such that waste heat is able to be transferred from the first cooling medium to the second element region, wherein the second cooling section is designed such that waste heat is able to be transferred from the first element region to the second cooling medium.

To this end, the first cooling section and/or the primary circuit is designed, in particular, such that the first cooling medium is able to be conducted to the respective second element region and, after the first cooling medium has transferred its waste heat to the respective second element region, is able to be conducted from the respective second element region to the parts of the electric machine to be cooled. Accordingly, the second cooling section and/or the secondary circuit is designed such that the second cooling medium is able to be conducted to the first element region and, after the second cooling medium has absorbed the waste heat of the first element region, is able to be conducted from the respective first element region, for example to a heat sink.

Preferably, a flow machine is provided in the first cooling section and/or in the second cooling section, the flow of the respective cooling medium being able to be driven thereby.

In a further advantageous embodiment of the invention, the respective heat transport element has at least four partial regions, wherein in a given rotational direction of the respective heat transport element
the first partial region is arranged inside the first element region where a local temperature of the heat transport element is able to be increased by means of a local increase in the magnetic alignment of the heat transport element,
the second partial region is arranged inside the first element region in the rotational direction adjacent to the first partial region,
   wherein waste heat is able to be transferred from the respective heat transport element via the second partial region to the second cooling medium,
the third partial region is arranged inside the second element region where a local temperature of the heat transport element is able to be reduced by means of a local reduction in the magnetic alignment of the heat transport element,
the fourth partial region is arranged inside the second element region in the rotational direction adjacent to the third partial region,
   wherein waste heat from the first cooling medium is able to be transferred to the respective heat transport element via the fourth partial region.

The first partial region, therefore, is that region of the respective heat transport element which is subjected to an increase in the magnetic field so that the magnetic moments are aligned in that region in a preferred direction and thus ordered. Since the magnetic field is usually increased within a short period of time, even at relatively low rotational speeds, generally an adiabatic process is present so that at the same time the local temperature also increases in that region.

The material of the second partial region has already passed through the step of adiabatic heating and thus has an additionally increased temperature. The second cooling medium is in thermal contact with the second partial region so that the waste heat of the second partial region is able to be transferred to the second cooling medium, whereby the second partial region is cooled.

The respective heat transport element in the third partial region is subjected to a reduction in the magnetic field, whereby the magnetic moments in that region tend to lose their preferred direction and thus become more misaligned. Since the magnetic field is generally reduced over a short period of time, an adiabatic process is once again present so that at the same time the local temperature also falls in that region.

The material of the fourth partial region has already been subjected to adiabatic cooling and therefore has an additionally reduced temperature. The first cooling medium which is in thermal contact with the fourth partial region, therefore, may transmit a particularly large quantity of waste heat to the fourth partial region, whereby the fourth partial region is heated.

By the rotation of the respective heat transport element, the individual points of the respective heat transport element pass through the above-described steps so that a cycle is formed.

In a further advantageous embodiment of the invention, the first cooling section in this case is designed such that the first cooling medium is initially able to be conducted to the fourth partial region and subsequently to the third partial region of the respective heat transport element.

As explained above, the fourth partial region of the respective heat transport element has a higher temperature than the third partial region so that the first cooling medium is initially conducted to the fourth, warmer partial region. The first cooling medium is subsequently conducted to the third, cooler partial region so that overall a particularly effective heat exchange is enabled between the first cooling medium and the respective heat transport element. Overall, a type of counter-current principle is implemented thereby.

In a further advantageous embodiment of the invention, the second cooling section in this case is designed such that the second cooling medium is initially able to be conducted to the second partial region and subsequently to the first partial region of the respective heat transport element.

The second cooling medium is thus conducted to the second, cooler partial region of the respective heat transport element as described above. Subsequently, the second cooling medium is conducted to the first, warmer partial region, whereby a particularly effective heat exchange is enabled between the respective heat transport element and the second cooling medium. By means of such an embodiment, once again, a type of counter-current principle is implemented.

In a further advantageous embodiment of the invention, the respective heat transport element has at least one convex element on its surface for increasing the surface area.

The at least one convex element serves for increasing the surface area, whereby the exchange with the first cooling medium and/or with the second cooling medium may be designed to be particularly effective. In particular, the quantity of waste heat which is able to be transferred to the respective heat transport element, and/or waste heat which is able to be transferred from the respective heat transport element, may be increased thereby. Preferably, the respective convex element comprises the magnetocaloric material.

In a further advantageous embodiment of the invention, the respective convex element is designed in this case as a rib, projection or propeller blade.

The rib may be designed in this case, in particular, to circulate in the circumferential direction or to extend in the axial direction, whereby mixed shapes, in particular a helical path-shaped design, may also be provided. For example, the projection may be designed as a protruding pin or the like.

By the design of the respective convex element as a propeller blade, firstly the surface area available for the heat exchange is increased so that the quantity of heat which is able to be exchanged is increased and secondly the respective propeller blade may be used to drive the flow of the respective cooling medium. In particular, a plurality of propeller blades may be provided so that overall, for example, a radial fan or axial fan may be reproduced, in particular when in each case co-current cooling is implemented relative to the two cooling media. Good cooling results may also be achieved, however, by counter-current cooling being provided in each case relative to the two cooling media.

In a further advantageous embodiment of the invention, at least one deflection element is provided, in each case the first cooling medium and/or the second cooling medium being able to be conducted to the respective heat transport element and/or being able to be conducted away from the respective heat transport element thereby and in each case the first cooling section being able to be substantially separated thereby from the second cooling section in terms of flow technology.

In order to reduce flow losses, in each case at least one deflection element is provided in the first cooling section and/or in the second cooling section. in particular, one respective flow element may also be used, the flow of the respective cooling medium in the flow direction being decelerated and/or accelerated thereby upstream and/or downstream of the respective element region, by the available flow cross section being increased and/or reduced by a diffuser-type and/or nozzle-type design of the respective flow element in the direction of flow. In this case, the respective flow element may be designed, in particular, as a deflection element.

The at least one deflection element may be used, in particular, for conducting coolant from and/or to the four aforementioned partial regions. For example, the first cooling medium may be initially conducted to the fourth, warmer partial region by at least one suitably shaped deflection element being provided and, in particular, a suitably designed channel being formed. Subsequently, the first cooling medium is conducted by the at least one deflection element to the third, cooler partial region and finally, in particular, to the parts of the electric machine to be cooled. Accordingly, the second cooling medium may be conducted through the at least one deflection element and/or a suitably designed channel to the second, cooler partial region of the respective heat transport element. Subsequently the second cooling medium is conducted by means of at least one deflection element to the first, warmer partial region and finally supplied, in particular, to a heat sink.

In a further advantageous embodiment of the invention, the electric machine comprises a rotor assembly and a stator assembly, wherein at least one part of the rotor assembly and/or the stator assembly is configured as the active part.

In the example of rotating electric machines, the rotor assembly is also denoted as the rotor and the stator assembly is denoted as the stator.

The electric machine is designed, for example, for producing a torque or for producing electrical energy, wherein the rotor assembly and the stator assembly are accordingly designed. Additionally, the rotor assembly and/or the stator assembly and/or at least one part of the rotor assembly and/or the stator assembly function as the aforementioned active part which is able to apply the magnetic field to the at least one heat transport element.

In particular, therefore, a subsidiary of a main excitation field of the electric machine may also be used for producing the required magnetic field. For example, the stator assembly is designed in order to provide a main excitation field, the rotor assembly being movably arranged therein. Accordingly, the stator assembly and/or a part of the stator assembly represents the aforementioned active part. Preferably, the corresponding electric machine is designed as a synchronous machine.

It is also conceivable that the rotor assembly is designed as an externally excited or permanently excited rotor which is arranged coaxially to the stator assembly. In this case, the rotor assembly has a greater axial extent that the stator assembly and/or the stator core so that a part of the rotor assembly protrudes over the stator assembly in the axial direction. The at least one heat transport element is preferably arranged in the axial extent of the stator assembly and/or the stator core such that it is able to interact with the protruding part of the rotor assembly. During a movement of the rotor assembly, the at least one heat transport element is thus subjected by its magnetocaloric material to vibrations of the magnetic field produced by the externally excited or permanently excited rotor, so that the aforementioned adiabatic cooling and heating processes take place.

Conversely, the stator assembly may also have a greater axial extent than the rotor assembly and/or the rotor core, wherein the at least one heat transport element is arranged, for example, in the axial extent of the rotor assembly, such that it is able to cooperate with the protruding part of the stator assembly.

In linear machines, an appropriate design of the stator assembly, the rotor assembly and the heat transport element is possible.

The further example may be provided where the electric machine is designed as an external rotor assembly, in particular as a wind power generator. The rotor assembly arranged radially outwardly in this case has at least one active part which is respectively designed, for example, as a permanent magnet or electrical winding for an externally excited rotor. In particular, the stator assembly arranged radially inwardly and/or a housing part arranged further radially outwardly has the at least one heat transport element. In this case, deflection elements rotating with the rotor assembly are provided, the aforementioned first cooling section, the second cooling section and/or such cooling channels being able to be configured thereby such that a first and a second cooling medium are separately conducted and waste heat from the first cooling medium to is able to be transferred to the respective heat transport element after it has passed through an adiabatic cooling, wherein additionally waste heat is able to be transferred from the respective heat transport element to the second cooling medium, after the respective heat transport element has passed through an adiabatic cooling.

In a further advantageous embodiment of the invention, the electric machine is designed as a generator or electric motor.

In a further advantageous embodiment of the invention, the electric machine is able to be operated at a power of more than 1 MW, in particular more than 10 MW.

Advantageously, the electric machine is designed as an external rotor assembly, in particular as a wind power generator.

The invention is described and explained in more detail hereinafter with reference to the exemplary embodiments shown in the figures and in which:

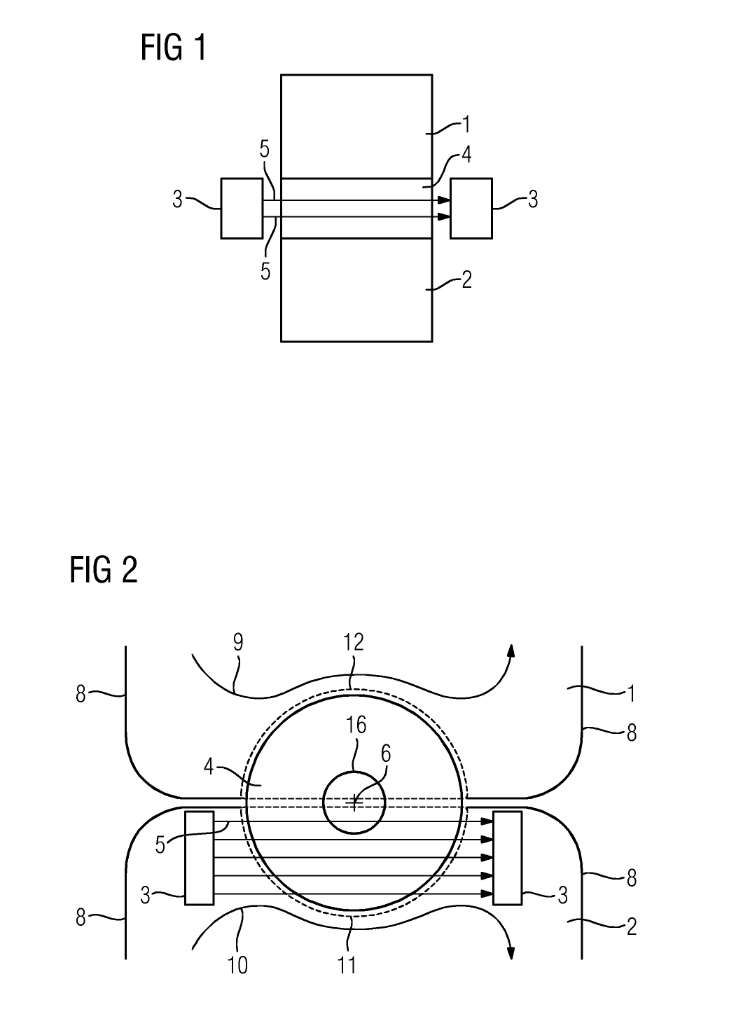

FIG. 1 shows a first exemplary embodiment of the electric machine according to the invention,

FIG. 2 shows a second exemplary embodiment of the electric machine according to the invention,

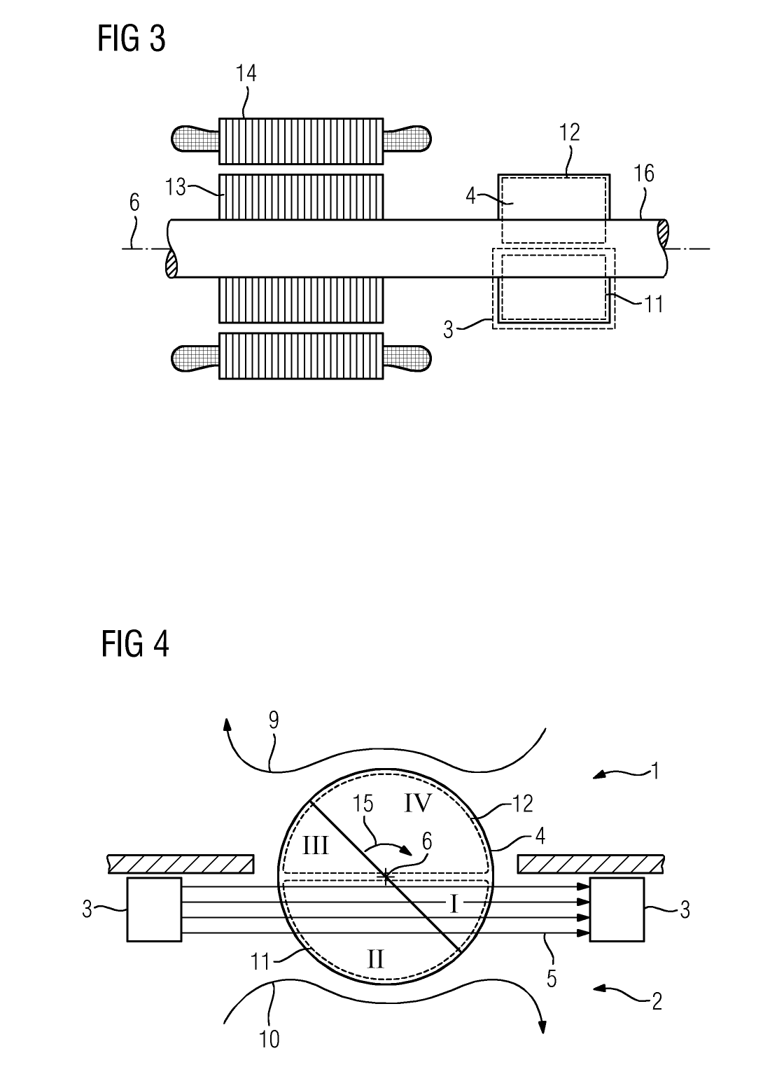

FIG. 3 shows an alternative view of the second exemplary embodiment,

FIG. 4 shows a third exemplary embodiment of the electric machine according to the invention,

FIG. 5 shows a fourth exemplary embodiment of the electric machine according to the invention,

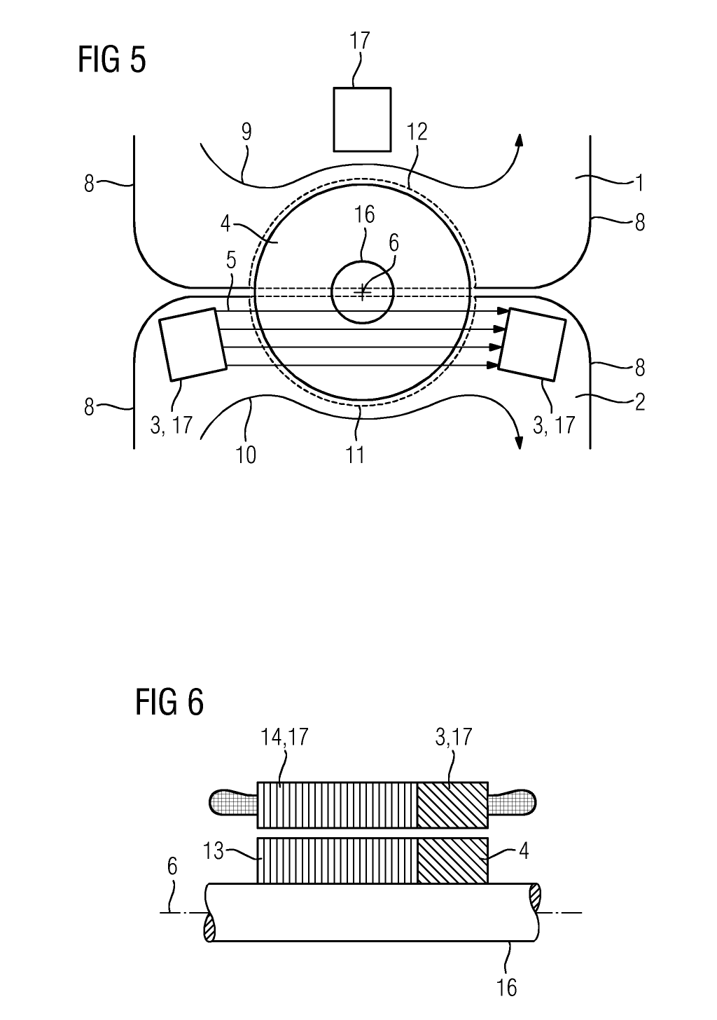

FIG. 6 shows an alternative view of the fourth exemplary embodiment, and

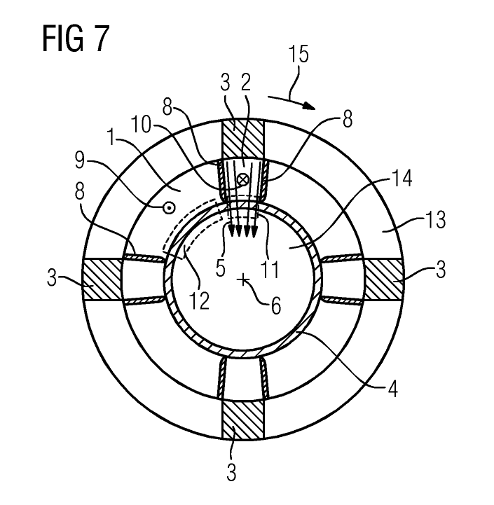

FIG. 7 shows a fifth exemplary embodiment of the electric machine according to the invention.

FIG. 1 shows a first exemplary embodiment of the electric machine according to the invention.

The electric machine comprises a first cooling section 1 and a second cooling section 2, wherein a first cooling medium is provided in the first cooling section 1 for cooling the electric machine. A heat transport element 4 which comprises a magnetocaloric material is arranged between the first cooling section 1 and the second cooling section 2. The electric machine comprises an active part 3, a magnetic field 5 being able to be applied thereby to the heat transport element 4 at least partially and/or at least temporarily. The arrows provided with the reference numeral 5 in FIG. 1 are intended to indicate the magnetic field lines of the magnetic field 5. The active part 3 and the heat transport element 4 in this case are, designed such that by using the magnetocaloric effect, waste heat from the first cooling medium is able to be transferred to a second cooling medium provided in the second cooling section 2.

FIG. 2 shows a second exemplary embodiment of the electric machine according to the invention, wherein a cross section is shown through the electric machine. In this case, the same reference numerals as in FIG. 1 denote the same objects.

According to the second exemplary embodiment, the heat transport element 4 is arranged around a shaft 16 which is able to be rotated about an axis of rotation 6 of the electric machine. A first element region 11 of the heat transport element 4 is located in a first machine region of the electric machine, the magnetic field 5 being able to be applied thereto by means of the active part 3. In this case, the active part 3 is positioned relative to the heat transport element 4 such that the magnetic field 5 is able to be applied to the halves of the heat transport element 4 shown at the bottom in FIG. 2. This half of the heat transport element 4, the magnetic field 5 being applied thereto, represents the first element region 11. A second element region 12 of the heat transport element 4 is arranged in a second machine region outside the first machine region, wherein the magnetic field 5 is not able to be applied to the second element region.

If the shaft 16 and the heat transport element 4 perform a rotational movement about the axis of rotation 6, parts of the heat transport element 4 are sometimes located in the first machine region, the magnetic field 5 being able to be applied thereto, and other parts of the heat transport element 4 are located at the same time in the second machine region. Accordingly, parts of the heat transport element 4 are sometimes located in the first element region 11 and other parts of the heat transport element 4 are located at the same time in the second element region 12. At a later time, the respective parts of the heat transport element 4 are located in each case in the other element region, due to the rotational movement.

Within the scope of the exemplary embodiment, the first and/or second cooling medium is conducted along the heat transport element 4 such that a coolant flow is formed, as indicated by the arrow provided with the reference numeral 9 and/or 10. For conducting the respective cooling medium, deflection elements 8 are provided. In particular, therefore, relative to one of the cooling media co-current cooling is shown and relative to the other of the cooling media counter-current cooling is shown.

The active part 3 may be arranged, as shown in FIG. 2, such that a magnetic field 5 is able to be produced which is substantially perpendicular to the axis of rotation 6 of the electric machine. Alternatively, the active part 3 may be designed such that the magnetic field 5 is substantially parallel to the axis of rotation 6 or mixed forms are present.

FIG. 3 shows an alternative view of the second exemplary embodiment, wherein a longitudinal section is shown through the electric machine. In this case the arrangement shown in FIG. 2 is indicated in the right-hand half of FIG. 3. For the sake of clarity, some details have been dispensed with.

The electric machine has a rotor assembly 13 designed as a rotor which is connected fixedly in terms of rotation to the shaft 16 and which is arranged inside a stator assembly 14 configured as a stator. The first cooling section 1 with the first cooling medium may serve, for example, to cool the stator assembly 14 and/or the rotor assembly 13, wherein the waste heat absorbed by the first cooling medium may be effectively removed by means of the heat transport element 4.

FIG. 4 shows a third exemplary embodiment of the electric machine according to the invention.

The heat transport element 4 has four partial regions I, II, III, IV which are shown in a given rotational direction 15 as follows. The first partial region I is arranged inside the first element region 11 where a local temperature of the heat transport element 4 is able to be increased by means of a local increase in the magnetic alignment of the heat transport element 4. The first partial region I is thus that region of the respective heat transport element 4 which during a rotation of the heat transport element 4 is subjected to an increase of the magnetic field 5. The second partial region II is arranged in the rotational direction 15 adjacent to the first partial region I, wherein via the second partial region II waste heat is able to be transferred from the heat transport element 4 to the second cooling medium. The third partial region III is arranged inside the second element region 12 where a local temperature of the heat transport element 4 is able to be reduced by means of a local reduction in the magnetic alignment of the heat transport element 4. Thus the third partial region 3 is located where, during a rotation, the heat transport element 4 is subjected to a reduction in the magnetic field 5. The fourth partial region IV is arranged in the rotational direction 15 adjacent to the third partial region III, wherein waste heat is able to be transferred from the first cooling medium to the heat transport element 4 via the fourth partial region IV.

The first cooling section 1 in this case is designed such that the first cooling medium is initially conducted to the fourth partial region IV and subsequently to the third partial region III, wherein the second cooling medium in the second cooling section 2 is conducted such that initially in the second partial region II and subsequently in the first partial region I it is in thermal contact with the heat transport element 4. Thus counter-current cooling is implemented for both cooling media. Deflection elements may be provided for conducting the respective cooling medium, said deflection elements being configured, in particular, as nozzles or diffusers.

The active part 3 may be arranged, as shown in FIG. 4, such that a magnetic field 5 which is substantially perpendicular to the axis of rotation 6 of the electric machine may be produced. Alternatively, the active part 3 may be designed such that the magnetic field 5 is substantially parallel to the axis of rotation 6 or mixed forms are present.

FIG. 5 shows a fourth exemplary embodiment of the electric machine according to the invention. Since some similarities with the second exemplary embodiment are present, differences between the fourth exemplary embodiment and the second exemplary embodiment are explained.

According to the fourth exemplary embodiment, the active part 3 is produced by two of the stator windings 17, the magnetic field 5 being able to be applied partially and/or temporarily to the heat transport element 4.

FIG. 6 shows an alternative view of the fourth exemplary embodiment, wherein a longitudinal section is shown through the electric machine. For the sake of clarity, some details have been omitted.

The electric machine has a rotor assembly 13 designed as a rotor, which is connected fixedly in terms of rotation to the shaft 16 and which is arranged inside a stator assembly 14 configured as a stator. For example, the rotor assembly 13 has a laminated core which adjoins the heat transport element 4 in the axial direction. In this case, the magnetic field 5 is able to be applied to the rotor assembly 13 with its laminated core and parts of the heat transport element 4 by means of the stator winding 17, wherein two of the stator windings 17 in the axial region of the heat transport element 4 function as the active part 3, as indicated in FIG. 5.

FIG. 7 shows a fifth exemplary embodiment of the electric machine according to the invention.

The electric machine is designed as an external rotor assembly, wherein a stator assembly 14 with a heat transport element 4 is arranged radially inwardly and a rotor assembly 13 is arranged radially outwardly, coaxially to the stator assembly 14, wherein the rotor assembly 13 is able to be rotated about an axis of rotation 6 in the rotational direction 15. The rotor assembly 13 has a plurality of active parts 3 which may be designed, for example, as permanent magnets and deflection elements 8 which are connected fixedly in terms of rotation to the remaining rotor assembly 13. The deflection elements 8 are arranged in pairs such that in each case a first cooling section 1 and a second cooling section 2 are able to be configured, in each case a first cooling medium and/or a second cooling medium being able to be conducted therein as is indicated by the arrow, facing out of the drawing plane and/or into the drawing plane, with the reference numeral 9 and/or 10.

In this case a magnetic field 5 is able to be applied to one respective first element region 11 of the heat transport element 4 by means of the respective active part 3, wherein one respective second element region 12 of the heat transport element 4 adjoins the respective first element region 11 in the rotational direction 15 and the magnetic field 5 is not able to be applied thereto and/or is applied to a lesser extent thereto.

By the rotation of the rotor assembly 13, parts of the heat transport element 4 are alternately subjected to an increase and/or a reduction in the magnetic field 5 so that the respective part of the heat transport element 4 is heated and/or cooled adiabatically. By means of the deflection elements 8 rotating together, the second cooling medium is able to be conducted such that the second cooling medium is always in thermal contact with the respective additionally heated region of the heat transport element 4, wherein the first cooling medium is able to be conducted using the deflection elements 8 rotating together, such that the first cooling medium is always in thermal contact with the respective additionally cooled region of the heat transport element 4. Overall, therefore, a particularly effective transfer of the waste heat of the first cooling medium to the second cooling medium is permitted.

In summary, the invention relates to an electric machine comprising a first cooling section in which a first cooling medium for cooling the electric machine is provided and a second cooling section in which a second cooling medium is provided. In order to provide an alternative to known cooling systems for electric machines, it is proposed that the electric machine has at least one active part and at least one heat transport element comprising a magnetocaloric material, wherein a magnetic field can be applied to the at least one heat transport element at least partially and/or at least temporarily by means of the at least one active part, wherein the at least one active part and the at least one heat transport element are designed in such a way that waste heat can be transferred from the first cooling medium to the second cooling medium by using the magnetocaloric effect.

What is claimed is:

1.-14. (canceled)

15. An electric machine, comprising:
a first cooling section configured for flow of a first cooling medium;
a second cooling section configured for flow of a second cooling medium;
at least one heat transport element comprising a magnetocaloric material; and
at least one active part configured to apply a magnetic field to the at least one heat transport element at least partially and/or at least temporarily,
the at least one active part and the at least one heat transport element being configured to transfer waste heat from the first cooling medium to the second cooling medium by using a magnetocaloric effect as the at least one heat transport element is exposed to the magnetic field.

16. The electric machine of claim 15, wherein the at least one heat transport element is arranged for rotation about an axis of rotation and/or for movement in a translatory manner, said at least one heat transport element having a first element region arranged in a first machine region of the electric machine, with the magnetic field, generated by the at least one active part, being applied to the first machine region, and a second element region arranged in a second machine region of the electric machine outside the first machine region.

17. The electric machine of claim 15, wherein the at least one active part is configured to align the magnetic field substantially along the axis of rotation.

18. The electric machine of claim 15, wherein the at least one active part is configured to align the magnetic field substantially perpendicular to the axis of rotation.

19. The electric machine of claim 16, wherein the first cooling section is configured to transfer waste heat from the first cooling medium to the second element region, and wherein the second cooling section is configured to transfer waste heat from the first element region to the second cooling medium.

20. The electric machine of claim 16, wherein the at least one heat transport element has at least four partial regions arranged such that when the at least one heat transport element rotates in a rotational direction, a first one of the partial regions is arranged inside the first element region at a location where a local temperature of the at least one heat transport element is increasable through local increase in a magnetic alignment of the at least one heat transport element, a second one of the partial regions is arranged inside the first element region in the rotational direction adjacent to the first partial region, with waste heat from the at least one heat transport element being transferable via the second partial region to the second cooling medium, a third one of the partial regions is arranged inside the second element region at a location where a local temperature of the at least one heat transport element is reducible through local reduction in the magnetic alignment of the at least one heat transport element, and a fourth one of the partial regions is arranged inside the second element region in the rotational direction adjacent to the third partial region, with waste heat from the first cooling medium being transferable to the respective heat transport element via the fourth partial region.

21. The electric machine of claim 20, wherein the first cooling section is configured to conduct the first cooling medium initially to the fourth partial region and subsequently to the third partial region of the at least one heat transport element.

22. The electric machine of claim 20, wherein the second cooling section is configured to conduct the second cooling medium initially to the second partial region and subsequently to the first partial region of the at least one heat transport element.

23. The electric machine of claim 15, wherein the at least one heat transport element has a surface provided with at least one convex element for increasing a surface area.

24. The electric machine of claim 23, wherein the convex element is configured in the form of a rib, projection, or propeller blade.

25. The electric machine of claim 15, further comprising at least one deflection element configured to conduct the first cooling medium or the second cooling medium to or away from the at least one heat transport element and to substantially separate a flow of the first cooling section from a flow of the second cooling section.

26. The electric machine of claim 15, further comprising a rotor assembly and a stator assembly interacting with the rotor assembly, said at least one active part being represented by a part of the rotor assembly or the stator assembly.

27. The electric machine of claim 15, constructed in the form of a generator or electric motor.

28. The electric machine of claim 15, constructed for operation at a power of more than 1 MW.

29. The electric machine of claim 15, constructed for operation at a power of more than 10 MW.
